(19) United States
(12) Patent Application Publication
(10) Pub. No.: US 2007/0097364 A1
(43) Pub. Date: May 3, 2007

(54) Active CMOS biosensor chip for fluorescent-based detection

(75) Inventors: Kenneth L. Shepard, Ossining, NY (US); Rastislav Levicky, Irvington, NY (US); George Patounakis, North Brunswick, NJ (US)

Correspondence Address: WilmerHale/Columbia University, 399 PARK AVENUE, NEW YORK, NY, 10022, US

(73) Assignee: The Trustees of Columbia University in the City of New York, New York, NY (US)

(21) Appl. No.: 11/431,405

(22) Filed: May 9, 2006

Related U.S. Application Data
(60) Provisional application No. 60/679,545, filed on May 9, 2005.

(51) Int. Cl. G01J 3/30; G01N 21/64

(52) U.S. Cl. 356/318; 250/458.1

(57) ABSTRACT

An active CMOS biosensor chip for fluorescent-based detection is provided that enables time-gated, time-resolved fluorescence spectroscopy. Analytes are loaded with fluorophores that are bound to probe molecules immobilized on the surface of the chip. Photodiodes and other circuitry in the chip are used to measure the fluorescent intensity of the fluorophore at different times. These measurements are then averaged to generate a representation of the transient fluorescent decay response unique to the fluorophores. In addition to its low-cost, compact form, the biosensor chip provides capabilities beyond those of macroscopic instrumentation by enabling time-gated operation for background rejection, easing requirements on optical filters, and by characterizing fluorescence lifetime, allowing for a more detailed characterization of fluorophore labels and their environment. The biosensor chip can be used for a variety of applications including biological, medical, in-the-field applications, and fluorescent lifetime imaging applications.

### CROSS-REFERENCE TO RELATED APPLICATION

This application claims the benefit under 35 U.S.C. § 119(e) of U.S. Provisional Patent Application No. 60/679,545, filed May 9, 2005, which is hereby incorporated by reference herein in its entirety.

### STATEMENT REGARDING FEDERALLY SPONSORED RESEARCH

This invention was made with United States Government support under Grant No. BES-0428544 awarded by the National Science Foundation. The United States Government may have certain rights in this invention.

### BACKGROUND OF THE INVENTION

1. Technical Field

The present invention relates to fluorescent-based detection. More particularly, the present invention relates to systems and methods for providing time-resolved fluorescent-based detection on an active complementary metal oxide semiconductor (CMOS) biosensor chip.

2. Description of the Related Art

An assay is a qualitative and/or quantitative analysis of an unknown analyte. In one example, an assay can be a procedure that determines the concentration and sequences of DNA in a mixture. In another example, an assay can be an analysis of the type and concentrations of protein in an unknown sample.

Surface-based sensing assays are typically performed in environmental and biomedical diagnostics. The detection of analytes (targets) in a mixture is often implemented at a solid-liquid interface. Passive solid supports, which include glass substrates or polymer membranes, have probe molecules (i.e., “probes”) immobilized on the surface of the solid supports that are used to bind the analytes of interest. Probes include, for example, proteins and nucleic acids. Probes are selected based on the analytes of interest such that there is a strong and specific interaction between a particular type of probe and a particular target.

More than one analyte can be detected using multiplexed detection. In multiplexed detection, different types of probes are arranged in an array on the surface of the solid supports. Each type of probe results in a strong and specific interaction with a different analyte of interest. For example, in DNA analysis, high density microarrays are used to examine gene expressions at the scale of entire genomes by simultaneously assaying mixtures derived from expressed mRNA against thousands of array sites, each bearing probes for a specific gene. Microarrays generally quantify target concentrations in relative terms, for example, in the form of a ratio to hybridization signal obtained using a reference target sample. Other biosensing applications are calibrated to provide absolute target concentrations.

Fluorescent-based detection is commonly used for quantifying the extent of probe-target binding in surface-based sensing assays. In fluorescent-based detection, a target is labeled with a fluorophore molecule, which can cause the target fluorophore to be fluorescent. Traditional microarray scanners include an excitation source, such as a laser, that emits light on the bound target fluorophores. This causes the target fluorophores to emit fluorescent light that is focused and collected (through a generally lossy optical path) onto a cooled charge-coupled device (CCD) or a photomultiplier tube (PMT). Optical filtering is typically used to improve the signal-to-noise ratio (SNR) by removing background light or reflected excitation light. In addition, the arrays are generally sensitive to particular fluorophore concentrations.

Characteristic lifetimes are associated with each fluorophore. The lifetime is defined by the transient exponential fluorescent decay of the fluorophore once the excitation source is removed. The lifetime, which is typically on the order of nanoseconds, is characteristic of the dye and the environment, and can be used in addition to color and intensity for multiplexed detection. Fluorescent lifetime detection, for example, has been employed for capillary electrophoresis in the time and frequency domain.

Known surface-based sensing assays are provided on macroscopic instruments. Such instruments are often expensive, large, and complex.

Therefore, there is a need in the art to provide a low cost, compact, and integrated chip for surface-based sensing arrays that provides capabilities similar to those on the macroscopic instruments

Accordingly, it is desirable to provide methods and systems that overcome these and other deficiencies of the prior art.

### SUMMARY OF THE INVENTION

In accordance with the present invention, systems and methods are provided for providing fluorescent-based assays on an active complementary metal oxide semiconductor (CMOS) biosensor chip.

An active CMOS biosensor chip for fluorescent-based assays is provided that enables time-gated, time-resolved fluorescence spectroscopy. Analytes are loaded with fluorophores that are bound to probe molecules immobilized on the surface of the chip. Photodiodes and other circuitry in the chip are used to measure the fluorescent intensity of the fluorophore at different times. These measurements are then averaged to generate a representation of the transient fluorescent decay response of the fluorophores, which is unique to the fluorophores. This data can then be used for further analysis of the analytes.

In addition to its low-cost, compact form, the biosensor chip provides capabilities beyond those of macroscopic instrumentation by enabling time-gated operation for background rejection, easing requirements on optical filters, and by characterizing fluorescence lifetime, allowing for a more detailed characterization of fluorophore labels and their environment. The biosensor chip can be used for a variety of applications including biological, medical, and in-the-field applications. The biosensor chip can be used for DNA and protein microarrays where the biomolecular probe is attached directly to the chip surface. The biosensor chip can also be used as a general fluorescent lifetime imager in a wide-field or confocal microscopy system.

According to one or more embodiments of the invention, a method is provided for fluorescent-based assays comprising the steps of: (a) receiving on a CMOS biosensor chip light from an excitation source; (b) directing the excitation source to turn off after a first time period; (c) measuring a fluorescent light emitted by at least one analyte having a fluorophore after a second time period measured from when the excitation source is directed to turn off, wherein the analyte is bonded to a probe molecule on the CMOS biosensor chip; (d) repeating steps (a)-(c) a number of times, wherein the second time period changes with each subsequent measuring; and (e) averaging results from each measuring.

According to one or more embodiments of the invention, a system is provided for fluorescent-based assays comprising an excitation source and a CMOS biosensor chip coupled to the excitation source. The CMOS biosensor chip is operative to (a) direct the excitation source to turn on; (b) direct the excitation source to turn off after a first time period; (c) measure a fluorescent light emitted by at least one analyte having a fluorophore after a second time period measured from when the excitation source is directed to turn off, wherein the analyte is bonded to a probe molecule on the CMOS biosensor chip; (d) repeat steps (a)-(c) a number of times, wherein the second time period changes with each subsequent measure; and (e) averaging results from each measure. The CMOS biosensor chip can include at least one driver, at least one photodiode, processing circuitry (e.g., sample-and-hold circuitry, analog-to-digital converter, and accumulator), and control circuitry. The CMOS biosensor can also include delay circuitry. In one embodiment, the system can be included in a camera for fluorescence microscopy.

According to one or more embodiments of the invention, an apparatus is provided for fluorescent-based assays. The apparatus comprises: a first printed circuit board on which is mounted an excitation source; a second printed circuit board on which is mounted a CMOS biosensor chip; and at least one cable with a first connector attached to the first printed circuit board and coupled to the excitation source and a second connector attached to the second printed board and coupled to the CMOS biosensor chip. The CMOS biosensor chip can be operative to measure a fluorescent decay response of at least one analyte having a fluorophore, wherein the analyte is bonded to a probe molecule on the CMOS biosensor chip, and wherein the fluorescent decay response is measured a plurality of times at a time period measured from a time when the excitation source is turned off after a period during which the excitation source is turned on.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with the other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like elements.

FIG. 1 is a block diagram of a sensor chip in accordance with an embodiment of the invention.

FIG. 2 is a timing diagram of time-resolved, time-gated fluorescent-based detection in accordance with an embodiment of the invention.

FIG. 3 is a die photograph of a sensor chip in accordance with an embodiment of the invention.

FIG. 4 is a schematic diagram of a pixel in accordance with an embodiment of the invention.

FIG. 5 is an equivalent circuit of the front-end of the pixel schematic shown in FIG. 4 in accordance with an embodiment of the invention.

FIG. 6 is a simplified top-level schematic diagram of a sensor chip in accordance with an embodiment of the invention.

FIG. 7 is a schematic diagram of the current-mode EA analog-to-digital converter shown in FIG. 6 in accordance with an embodiment of the invention.

FIG. 8 is a block diagram of fluorescent-based detection system in accordance with an embodiment of the invention.

FIG. 9 is a flow chart illustrating different states of a fluorophore during fluorescent-based detection in accordance with an embodiment of the invention.

FIGS. 10-11 are flow charts illustrating processes for fluorescent-based detection in accordance with different embodiments of the invention.

### DETAILED DESCRIPTION OF THE INVENTION

In the following description, numerous specific details are set forth regarding the systems and methods of the present invention and the environment in which such systems and methods may operate, etc., in order to provide a thorough understanding of the present invention. It will be apparent to one skilled in the art, however, that the present invention may be practiced without such specific details, and that certain features, which are well known in the art, are not described in detail in order to avoid complication of the subject matter of the present invention. In addition, it will be understood that the examples provided below are exemplary, and that it is contemplated that there are other systems and methods that are within the scope of the present invention.

In accordance with the present invention, an active complementary metal oxide semiconductor (CMOS) biosensor chip is provided for fluorescent-based detection. The present invention provides several advantageous. The chip enables time-gated, time-resolved fluorescence spectroscopy. A time-gated operation provides additional background rejection and eases requirements on optical filters. In microarray applications, the chip also provides for probe molecules to be immobilized directly on the surface of the chip, thereby eliminating losses associated with the use of large and complex optical filters and also allows for efficient solid-angle collection. In addition, the ability to distinguish a fluorophore lifetime advantageously offers the potential to detect the presence of two different fluorophores without the need for multiple optical filters.

Most time-resolved fluorescence systems rely on real-time photodetection with a photomultiplier (PMT), which provides high gain and high sensitivity. Photodiodes, which are photosensitive devices compatible with a CMOS process, do not have gain, but use averaging (e.g., in the form of integrating photocurrent onto a capacitor and averaging the results of multiple measurements) in order to achieve a high signal-to-noise ratio (SNR).

High sensitivity can be achieved using a real-time detection application to extract a transient fluorescent decay response that follows the rapid turn-off of an excitation source (e.g., laser). To preserve the sensitivity benefits of averaging and to reduce the bandwidth requirements on circuit components, sub-sampling is used to achieve this real-time detection. The transient response is repeated a number of times. During each time, the integral of the photodiode current (iₚₕₒₜₒ(t)) is taken from a different starting time (tᵣₑₛₑₜ) relative to the laser turn-off time, generating output

$${\int }_{treset}^{∞} {i}_{photo} ( t ) ⅆ t .$$

The result for a single starting time (tᵣₑₛₑₜ) can also be repeated to improve the overall detection sensitivity. The photodiode current transient, which is directly proportional to the instantaneous fluorescence, can be generated by numerical differentiation.

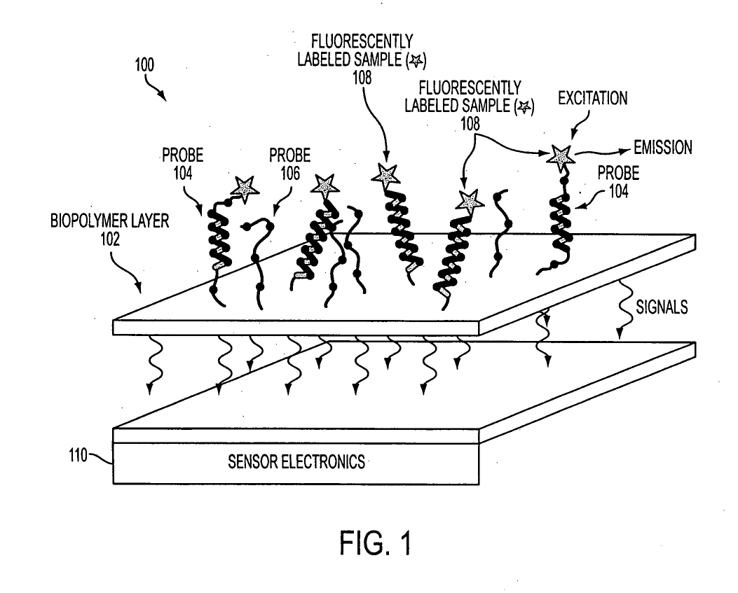

FIG. 1 is a block diagram of a sensor chip 100 in accordance with an embodiment of the invention. Chip 100 includes a solid support such as a biopolymer layer 102 with probe molecules 104 and 106 (e.g., proteins and nucleic acids) immobilized on the solid support. Probes 104 and 106 are used to bind to different analytes in a mixture. For example, analytes 108 bind to probes 104 and not to probes 106. Chip 100 also includes sensor electronics 110 that detect and process signals generated by analytes 108. Although chip 100 is described herein primarily in the context of using a biopolymer layer 102 as a solid support and having two different probes 104 and 106 immobilized on the solid support for clarity, chip 100 may include any other suitable type of solid support and may have any suitable number of different types of probes for binding to different analytes.

Analytes may be labeled with fluorophore molecules. The fluorophores are originally in a ground state. During an excitation process, an excitation source (e.g., a laser) (not shown) directs a light on chip 100. The fluorophores absorb the light, thereby increasing its energy levels until the fluorophores reach a high-energy excited state. Because the fluorophores are unstable in the high-energy excited state, during an excited lifetime process, the fluorophores lose some of its energy and adopt a lower energy excited state to become semi-stable. During an emission process, the fluorophores releases its excess energy by emitting light until the fluorophores return to the ground state.

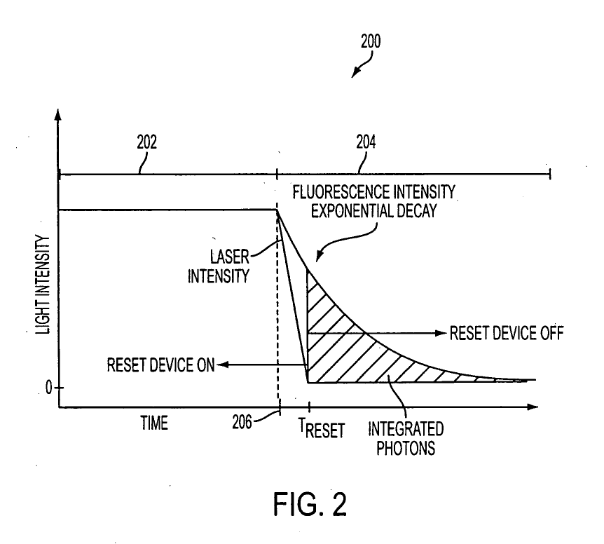

FIG. 2 is a timing diagram 200 of time-resolved, time-gated fluorescence detection illustrating a first time period 202 when an excitation source such as a laser is turned on and a second time period 204 when the laser is turned off. During time period 202, the laser emits a light, causing fluorophores in analytes 108 to absorb the light and to reach an excited state. The fluorescence intensity of the fluorophores is high. At time 206, the laser is turned off. During time period 204, the intensity of the fluorophores decays at a substantially exponential rate until the ground state is reached. In order to extract the fluorescent decay response, sub-sampling of the fluorescence intensity (which can be a measure of the photodiode current) from different starting times tᵣₑₛₑₜ relative to time 206, can be measured. These measurements can be averaged to generate a value representing the area under the fluorescent decay response curve (i.e., the integral of the photodiode current).

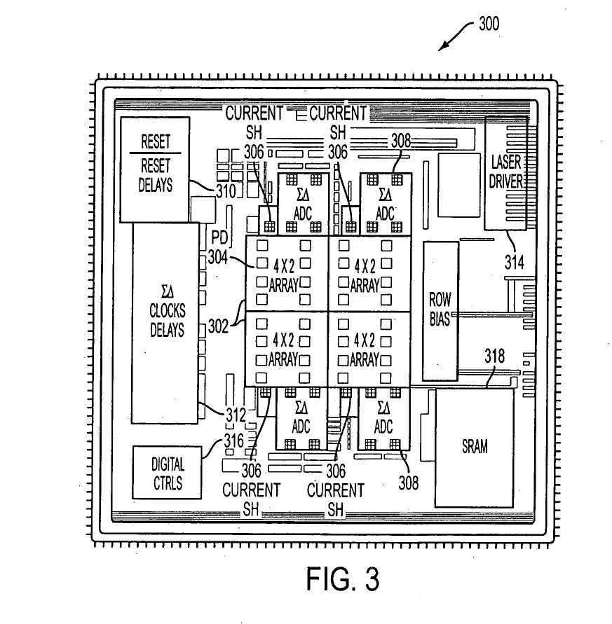

FIG. 3 is a die photograph of a sensor chip 300 in accordance with one embodiment of the invention. Chip 300 can be a 5 mm×5 mm CMOS biosensor chip fabricated in a mixed-signal 0.25 μm process. Chip 300 includes an 8×4 pixel array that is divided into four banks (e.g., each bank is arranged as a 4×2 array 302) of eight pixels (each having a photodiode) 304, four current sample-and-hold (SH) circuits 306, four current-mode ΣΔ analog-to-digital converters (ADCs) 308, reset delay circuitry 310, ΣΔ clocks delay circuitry 312, laser drivers 314, a digital controller 316, and a static random access memory (SRAM) 318. Laser drivers 314 control the operation of an excitation source such as a laser. When the laser driver 314 sends a signal to the laser indicating that the laser is to be turned off, reset delay circuitry 310 receives and delays a reset signal (and its complement signal) by a time tᵣₑₛₑₜ, which is measured relative to the timing of laser drivers 314. The delayed reset signal is sent to pixels 304 in arrays 302 (e.g., to pixel reset predrivers). Pixels 304 receive fluorescent light from the fluorophores, and, upon receiving the delayed reset signal, send as output currents reflecting the fluorescence intensity of the fluorophores. The output currents are time-multiplexed into four SH circuits 306, which sample the currents and hold the currents for a period of time. The sampled current from each SH circuit 316 is sent as input to a respective ΣΔ ADC 308, which converts the sampled current from an analog format to a digital format. ΣΔ ADC 308 is controlled by ΣΔ clocks delay circuitry 312. Digital results are stored in an on-chip memory such as SRAM 318. Digital controller 316, which can be configured externally with a serial bit stream, generates the clocks and control signals for ΣΔ ADCs 308, steps through the appropriate tᵣₑₛₑₜ values, controls the storage of digital samples, and determines the laser pulse duration.

Although FIG. 3 is described herein as being a particular dimension fabricated on a particular process, with certain configurations of circuitry, any other suitable sizes, processes, and configurations of circuitry may be used.

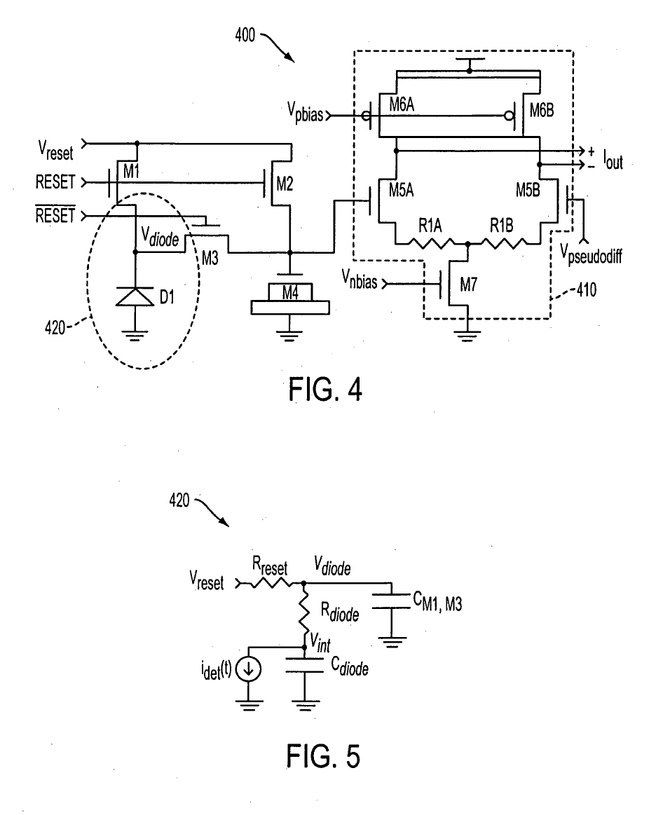

FIG. 4 is a schematic diagram 400 of a pixel 304. Circuit 400 includes two reset transistors M1 and M2, an isolation device M3, a storage capacitor M4, a transconductor 410, and a diode D1 420. Diode 420 can be an n-well/p-sub photodiode. The photodiode in pixel 304 preferably includes an n-well guard ring to collect carriers generated by neighboring pixels 304. Transconductor 410 includes multiple transistors M5A, M5B, M6A, M6B, and M7, and two resistors R1A and R1B. Resistors R1A and R1B can be non-silicided polysilicon resistors that are used to linearize transconductor 410 through source degeneration. Transconductor 410 converts the voltage across storage capacity M4, which results from the integrated photocurrent, into a differential current (Iₒᵤₜ) for subsequent current-mode data conversion. The transistors in diagram 400 may be any suitable type of transistor having any suitable size. In embodiment, transistors M5A, M5B, and/or M7 can be large input n-field-effect transistors (n-FETS) to reduce 1/f noise and to improve matching performance.

During the reset phase, as determined by the RESET signal being set to high (i.e., binary “1”), transistor M3 is in an OFF state, effectively isolating M4 from D1. This reduces the capacitance on node V_{diode} to the reverse-biased capacitance of D1 and the capacitances of M1 and M3. Transistor M1 is in an ON state, and is sized to provide a triode region resistance of Rᵣₑₛₑₜ that allows V_{diode} to be held within a particular voltage of Vᵣₑₛₑₜ, even for large photodiode currents associated with the excitation source. Isolation transistor M3 is sized such that it mitigates some of the voltage offset associated with charge-injection from transistor M1.

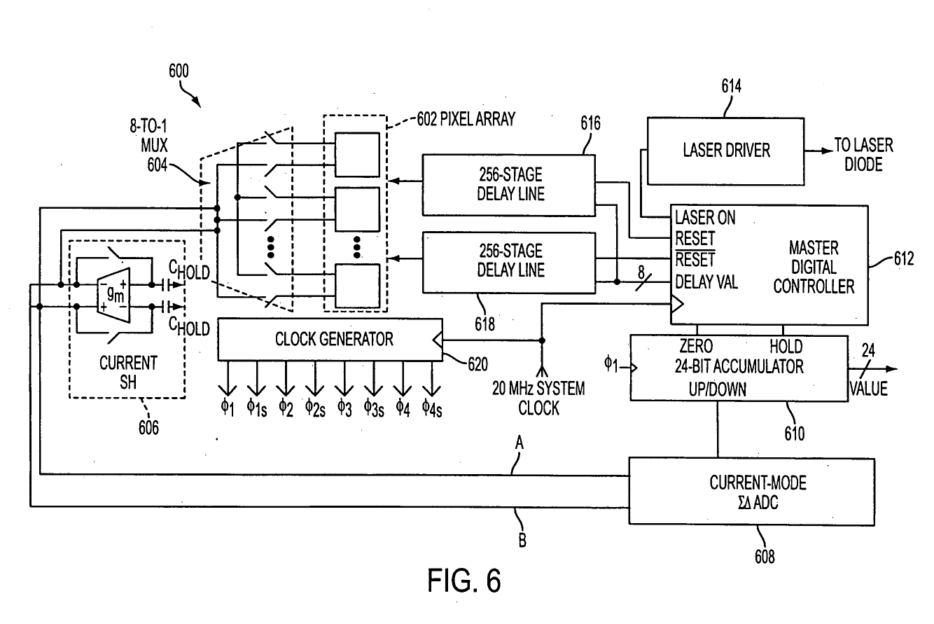

FIG. 5 shows an equivalent circuit of the front-end of pixel diagram 400 (diode 420) during reset phase. R_{diode} is the parasitic resistance associated with the n-well bulk connection to diode 420. The value of R_{diode} limits the maximum sustainable photocurrent before blooming can occur in diode 420. The bandwidth critical response of the pixel is determined by how quickly the internal diode voltage across C_{diode} can track the external diode voltage V_{diode}. Two time constants are associated with circuit 400: τ_{diode}=(R_{diode}+Rᵣₑₛₑₜ)C_{diode} and τ_{M1,M3}=RᵣₑₛₑₜC_{M1,M3}. The laser diode pulse fall-time is preferably greater than both time constants for the pixel to track the photocurrent up to tᵣₑₛₑₜ. Transistor M3 acts to provide a larger capacitance for charge integration while removing the capacitance (that of transistor M4) from the performance-limiting time constants.

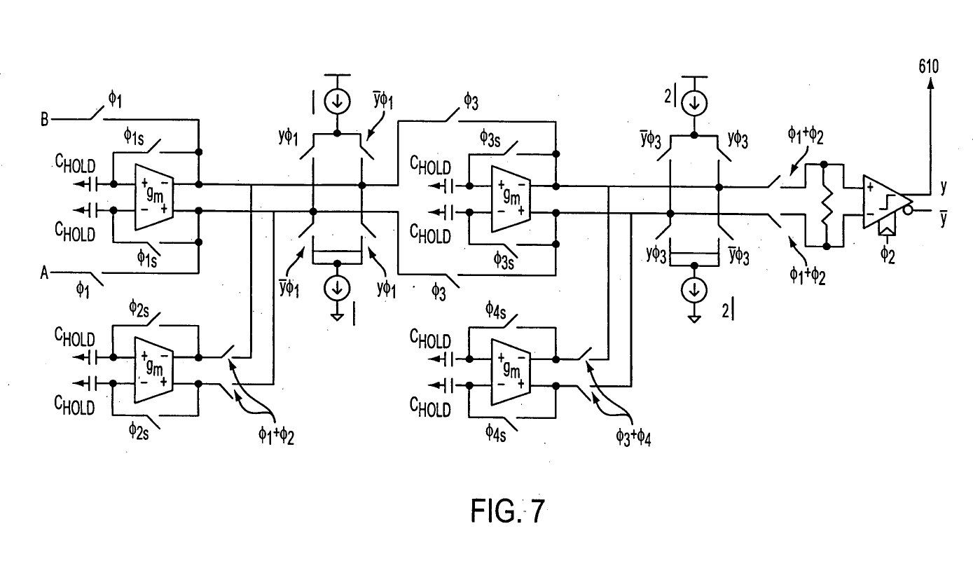

FIG. 6 is a simplified top-level schematic diagram 600 of a sensor chip. Circuit 600 includes the components similar to those illustrated in chip 300 (FIG. 3). Circuit 600 includes an array 602 having a number of pixels. In one embodiment, array 602 can be array 302 having eight pixels. Array 602 sends as output differential signal currents for each of the pixels, which are time-multiplexed using multiplexer 604 onto a current-mode SH element 606. In one embodiment, current-mode SH element 606 can be current SH circuit 306. Current-mode SH element 606 can include a differential transconductor with two feedback storage capacitors.

The output of current-mode SH element 606 is continuously sampled by current-mode ΣΔ ADC 608. In one embodiment, current-mode ΣΔ ADC 608 can be ΣΔ ADC 308. Using a sampled version of the pixel current rather than sending the pixel current directly into ΣΔ ADC 608 advantageously reduces charge-injection and clock feed-through noise coupling back into array 602 through multiplexer 604.

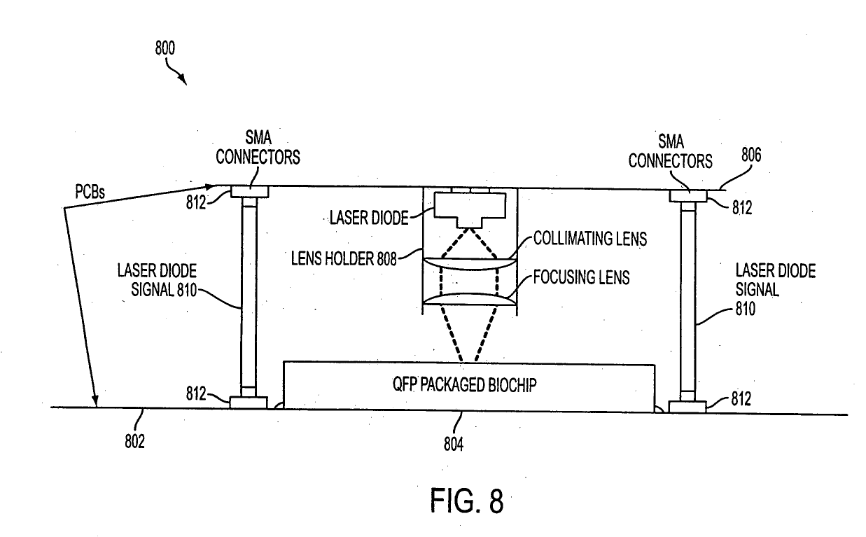

FIG. 7 shows a schematic diagram of ΣΔ ADC 608. ΣΔ ADC 608 can be is a fully-differential, second-order, one-bit current-output circuit with a full-scale input level. ΣΔ ADC 608 includes two cascade current sources and a switch network. Pattern-dependent supply loading can be mitigated with current-switch design by providing a fixed current across each ΣΔ ADC 608. Four non-overlapping clocks from clock generator 620 are used to achieve a settling accuracy (e.g., of 12 bits) in the discrete-time current-copier integrators. In one embodiment, clock generator 620 can be ΣΔ clocks delay circuitry 312.

In one embodiment, the transconductors in ΣΔ ADC 608, as well as the transconductors in current-mode SH element 606, can use source-degenerating polysilicon resistors, which have a nominal transconductance. The transconductors in ΣΔ ADC 608 can be further enhanced with active cascade topologies in the output stage to boost output resistance, thereby advantageously minimizing gain error from current division.

ΣΔ ADC 608 generates a one-bit “up” or “down” output that is sent as input to a 24-bit accumulator 610. In one embodiment, accumulator 610 can be a low-pass digital filter. The 12-bit (or other suitable number of bits) value generated by accumulator 610 after running ΣΔ ADC 608 for a number of cycles (e.g., 4096 cycles) has a relative accuracy of approximately 11 bits, limited by idle tones in ΣΔ ADC 608. The measured detrimental effect of idle tones is less than what behavioral modeling of ΣΔ ADC 608 predicts because of the dithering effect of noise at the input of the ΣΔ ADC 608 from current-mode SH element 606 and other analog noise signals in the ΣΔ ADC 608 loop.

Results from accumulator 610 are cached into an on-chip memory (e.g., SRAM 318). This eliminates the need for firing noisy off-chip drivers during repeated measurements. The outputs of the four accumulators 610 (each associated with a different array 302), are sent as input to an SRAM controller that coordinates writing this data to a single memory array. The address space of SRAM 318 is organized by sub-blocks and by which pixel within the sub-block is being written. SRAM 318 can be written in a single-pixel mode (e.g., a maximum of 2048 24-bit pixels values) or in a multiple-pixel mode (e.g., 64 values for each of 32 pixels). When measurements are completed and stored in SRAM 318, the entire contents of SRAM 318 can then be loaded off-chip.

Circuit 600 also includes master digital controller 612, which drives both the array reset signal and the excitation source (e.g., a laser). In one embodiment, master digital controller 612 can be digital controller 316. Controller 612 can vary the skew between the signals of the reset signal and the laser to achieve time-resolved fluorescence detection. Laser driver 614 can include a variable width inverter with independent tunability of the pull-up and pull-down widths, selected digitally using control words. In one embodiment, laser driver 614 can be laser driver 314. Laser diodes with larger operating voltages can be accommodated by using thick oxide input/output (I/O) in the output circuitry of the laser driver. This also allows the laser diode to tolerate overshoot at the near-end, which sometimes occurs as a result of reflections against the highly nonlinear load resistance turn-on characteristic of the laser diode.

The maximum current sourcing capability can be at any suitable voltage output that is sufficient to drive commercial laser diodes with certain optical outputs. Larger laser diodes can be sized such that they can be suitably driven by off-chip transmission lines in parallel. Pulse width and synchronization can be determined by controller 612.

Circuit 600 further includes programmable, variable delay lines 616 and 618 used to trigger the pixel reset predrivers in array 602. Delay line 616 delays the reset signal while delay line 618 delays the complement of the reset signal. The delay can be any suitable multiple of the period of the system clock combined with sub-clock period delay generation using an n-stage (e.g., n=256) inverter chain delay line. For example, for a system clock of 20 MHz, the delay can be any multiple of the system clock (T_{cycle}=50 ns) combined with any multiple of the stage delay T_{delay} such that the reset time is tᵣₑₛₑₜ=nT_{cycle}+mT_{delay} (where n and m are positive integers). An n-bit multiplexer can be used to choose one of the phases in each delay line 616 and 618. The phases in each delay line 616 and 618 are preferably the complement of the other. Each delay line 616 and 618 and multiplexer is designed to limit mismatch between buffer stages that results from layout parasitics.

Large on-chip drivers for the reset and laser diode drivers (e.g., 616, 618, and 614) are designed to rapidly switch to achieve sufficient resolution for time-resolved detection. This can result in power-supply and substrate noise issues that may be a concern for the sensitive analog circuits of array 602 and ΣΔ ADC 608. Several techniques can be implemented to minimize these issues. For example, the slew rate of the reset signal can be limited to control noise generation. Array 602 and ΣΔ ADC 608 can be isolated from one another and other circuitry using a double guard ring. Supplies can be separated and decoupled on the chip. Data inputs to, and data outputs from, the chip can also be separated (e.g., all bias currents and voltages can sent as input into one side of the chip while all digital signals can be interfaced from another side of the chip).

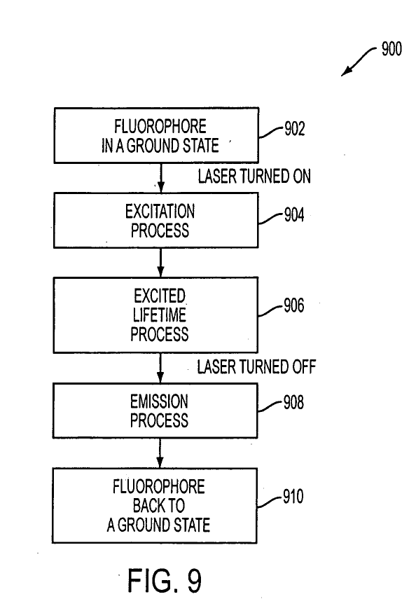

FIG. 8 is a block diagram of is a block diagram of fluorescent-based detection system 800 in accordance with an embodiment of the invention. System 800 includes a first printed circuit board (PCB) 802. A biochip sensor, which can be packaged in a ceramic quad-flat-pack (QFP) package 804, is mounted on PCB 802. In one embodiment, the biochip sensor can include the circuitry shown in FIGS. 3-7. System 800 also includes a second PCB 806. Laser circuitry 808, which includes a laser diode, a lens holder, a collimating lens, and a focusing lens, is mounted on PCB 806. In one embodiment, the laser diode can be a 635 nm, 5 mW AlGaInP diode packaged in a 9 mm CAN style package. Alternatively, any other suitable diode can be used. PCB 806 is mounted over PCB 802 such that circuitry 808 can direct the light over analytes bound to the probes on the surface of biochip 804. Cables 810 with connectors 812 (e.g., SubMiniature version A or SMA connectors) are used to connect laser circuitry 808 to each of the laser drivers (e.g., laser drivers 314 or 614) on biochip 804.

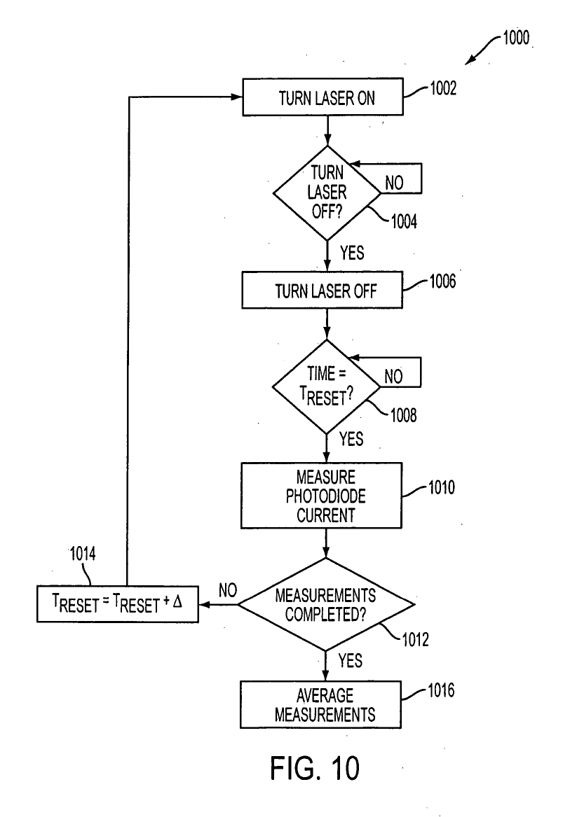

FIG. 9 is a flow chart illustrating different states of a fluorophore during fluorescent-based detection. Process 900 begins at step 902 where a fluorophore is in a ground state. When an excitation source such as a laser is turned on, process 900 moves to an excitation process at step 904. During the excitation process, a fluorophore absorbs light, increasing its energy level until it reaches a high energy excited state. Process 900 then moves to an excited lifetime process at step 906. During the excited lifetime process, the fluorophore loses some of its energy to adopt a lower energy excited state. When the laser is turned off, process 900 moves to an emission process 908. During the emission process, the fluorophores releases its excess energy by emitting light until the fluorophore returns to the ground state at step 910.

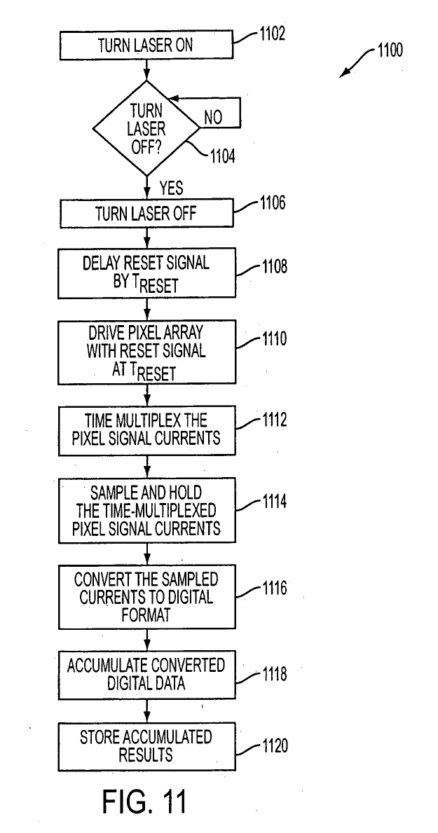

FIG. 10 is flow chart illustrating a process 1000 for fluorescent-based detection in accordance with one embodiment of the invention. Process 1000 begins at step 1002 where an excitation source such as a laser is turned on. At step 1004, process 1000 determines whether the laser should be turned off. The laser may be programmed to be turned off after a predetermined time period, based on particular conditions (e.g., based on measurements in the array), or based on any other suitable measurement. When the laser is to remain on, process 1000 remains at step 1004. When the laser is to be turned off, process 1000 moves to step 1006 where the laser is turned off. The operation of the laser may be controlled by any suitable circuitry such as, for example, controllers 316 and 612 and/or laser drivers 314 or 614.

At step 1008, process 1000 determines whether the time that has elapsed, which is measured from the time that the laser is turned off, equals a particular rest time (tᵣₑₛₑₜ). The reset time may be any suitable time and may be controlled by any suitable circuitry such as, for example, controllers 316 and 612 and/or delay lines 310, 616, and 618. When the reset time has not elapsed, process 1000 remains at step 1008. When the reset has elapsed, process 1000 moves to step 1010 where the photodiode current (in a pixel 304) is measured. At step 1012, process 1000 determines whether the measurements are completed. When the measurements are not completed, process 1000 moves to step 1014 where the reset time is changed (e.g., tᵣₑₛₑₜ is incremented by a particular amount Δ). Process 1000 then returns to step 1002 where the process is repeated so that another measurement of the photodiode current can be taken at a different reset time (tᵣₑₛₑₜ=tᵣₑₛₑₜ+Δ).

Any suitable number of measurements may be taken using any suitable number of reset times (tᵣₑₛₑₜ) such that the measurements can be used to uniquely identify the transient fluorescent decay response of a given fluorophore from other fluorophores. For each subsequent measurement, the reset time may change by the same predetermined incremental value. Alternatively, for each subsequent measurement, the rest time may change using different incremental values (e.g., as the elapsed time from the time that the laser is turned off increases, the incremental value may also increase). In another embodiment, the same reset time may be used for subsequent measurements to improve the overall detection sensitivity. The reset time may be set and/or changed by any suitable circuitry such as, for example, controllers 316 and 612 and/or delay lines 616 and 618.

When the measurements are completed at step 1012, process 1000 moves to step 1016 where the measurements are averaged to generate a representation of the transient fluorescent decay response of a particular fluorophore. These measurements can then be stored in an on-chip memory such as SRAM 306 or used for further processing of the data. Steps 1010, 1012, and 1016 may be performed using any suitable circuitry such as, for example, current SH elements 306 or 606, ΣΔ ADCs 308 or 608, and/or accumulator 610.

FIG. 11 is flow chart illustrating a process 1100 for fluorescent-based detection in accordance with another embodiment of the invention. Process 1100 begins at step 1102 where an excitation source such as a laser is turned on. At step 1104, process 1100 determines whether the laser should be turned off. The laser may be programmed to be turned off after a predetermined time period, based on particular conditions (e.g., based on measurements in the array), or based on any other suitable measurement. When the laser is to remain on, process 1100 remains at step 1104. When the laser is to be turned off, process 1100 moves to step 1106 where the laser is turned off. The operation of the laser may be controlled by any suitable circuitry such as, for example, controllers 316 and 612 and/or laser drivers 314 and 614.

At step 1108, a reset signal may be delayed prior to being sent to array 302 or 602. For example, the reset signal (and its complement signal) may be sent from controller 612 to delay line 616 (and 618) when the laser is turned off. Delay line 616 may delay the reset signal by a reset time (tᵣₑₛₑₜ) (as described above in connection with FIG. 10). When the reset time has elapsed, process 1100 moves to step 1110 where the process drives pixel reset predrivers in array 302 or 602 with the delayed reset signal, causing the pixels in array 302 or 602 to output pixel signal currents. At step 1112, process 1100 time multiplexes the pixel signal currents. This may be performed using multiplexer 604. At step 1114, the time-multiplexed pixel signal currents are sampled and held for a period of time. This may be performed using current SH circuits 306 or 606. After the period of time, the sampled currents are converted from analog to digital format at step 1116. This may be performed using ΣΔ ADCs 308 or 608. At step 1118, process 1100 accumulates the converted data. This may be performed using accumulator 610. Although steps 1116 and 1118 are shown as separate sequential steps, ΣΔ ADCs 308 or 608 perform many cycles of converting sampled currents to digital format and sending the output to accumulator 610. Once all the data is accumulated, process 1100 moves to step 1120 where the accumulated results are stored. The results may be stored in an on-chip memory such as SRAM 306.

Process 1100 illustrates a process for fluorescent-based detection measured at one rest time (tᵣₑₛₑₜ). Although not shown, process 1100 may be repeated a number of times. In one embodiment, the reset time in which fluorescent-based detection is measured may change with each subsequent measurement. In another embodiment, the reset time in which the fluorescent-based detection is measured may be the same with each subsequent measurement.

An active CMOS biosensor chip for fluorescent-based assays is provided that enables time-gated, time-resolved fluorescence spectroscopy. In addition to its low-cost, compact form, the biosensor chip provides capabilities beyond those of macroscopic instrumentation by enabling time-gated operation for background rejection, easing requirements on optical filters, and by characterizing fluorescence lifetime, allowing for a more detailed characterization of fluorophore labels and their environment. The biosensor chip can be used for a variety of applications including biological, medical, and in-the-field applications. The biosensor chip can be used for DNA and protein microarrays where the biomolecular probe is attached directly to the chip surface. The biosensor chip can also be used as a general fluorescent lifetime imager in a wide-field or confocal microscopy system.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow.

What is claimed is:

1. A method for fluorescent-based detection comprising:
(a) receiving on a complementary metal oxide semiconductor (CMOS) biosensor chip light from an excitation source;
(b) directing the excitation source to turn off after a first time period;
(c) measuring a fluorescent light emitted by at least one analyte having a fluorophore after a second time period measured from when the excitation source is directed to turn off, wherein the analyte is bound to a probe molecule on the CMOS biosensor chip;
(d) repeating steps (a)-(c) a number of times, wherein the second time period changes with each subsequent measuring; and
(e) averaging results from each measuring.

2. The method of claim 1 wherein the probe molecule is immobilized on the surface of the CMOS biosensor chip.

3. The method of claim 1 wherein measuring the fluorescent light comprises measuring current across a photodiode.

4. The method of claim 1 further comprising:
repeating steps (a)-(c) a second number of times, wherein the second time period is the same with each subsequent measuring; and
averaging results from each measuring that use the same second time period.

5. The method of claim 1 wherein the measuring comprises:
driving a photodiode with a reset signal at the end of the second time period;
receiving a current across the photodiode;
sampling the current;
converting the sampled current from an analog format to a digital format; and
accumulating the converted sampled current.

6. A system for fluorescent-based detection comprising:
an excitation source; and
a complementary metal oxide semiconductor (CMOS) biosensor chip coupled to the excitation source, wherein the CMOS biosensor chip is operative to:
(a) direct the excitation source to turn on,
(b) direct the excitation source to turn off after a first time period,
(c) measure a fluorescent light emitted by at least one analyte having a fluorophore after a second time period measured from when the excitation source is directed to turn off, wherein the analyte is bound to a probe molecule on the CMOS biosensor chip,
(d) repeat steps (a)-(c) a number of times, wherein the second time period changes with each subsequent measure, and
(e) average results from each measure.

7. The system of claim 6 wherein the CMOS biosensor chip comprises:
at least one driver operative to direct the excitation source to turn on and off;
at least one photodiode operative to receive the fluorescent light; and
processing circuitry operative to measure the fluorescent light and average results from each measure; and
control circuitry operative to control the operation of driver, the photodiode, and the processing circuitry.

8. The system of claim 7 further comprising delay circuitry operative to delay a reset signal by the second time period, wherein the output of the delay circuitry is used to drive the photodiode.

9. The system of claim of claim 7 wherein the processing circuitry further comprises:
sample-and-hold circuitry operative to sample the current from the photodiode;
an analog-to-digital converter operative to convert the sampled current from an analog format to a digital format; and
an accumulator operative to accumulate the converted sampled current.

10. The system of claim 6 wherein the CMOS biosensor chip is further operative to:
repeat steps (a)-(c) a second number of times, wherein the second time period is the same with each subsequent measure; and
averaging results from each measure that use the same second time period.

11. The system of claim 6 wherein the excitation source is a laser.

12. The system of claim 11 wherein the laser comprises a laser diode, a colliminating lens, and a focusing lens held by a lens holder.

13. The system of claim 6 further comprising:
a first printed circuit board on which is mounted the excitation source;
a second printed circuit board on which is mounted the CMOS biosensor chip; and
at least one cable with a first connector attached to the first printed circuit board and coupled to the excitation source and a second connector attached to the second printed circuit board and coupled to the CMOS biosensor chip.

14. The system of claim 6 wherein the CMOS biosensor chip is a ceramic quad-flat-pack packaged biochip.

15. A camera for fluorescence microscopy comprising the system of claim 6.

16. Apparatus for fluorescent-based detection comprising:
a first printed circuit board on which is mounted an excitation source;
a second printed circuit board on which is mounted a complementary metal oxide semiconductor (CMOS) biosensor chip; and
at least one cable with a first connector attached to the first printed circuit board and coupled to the excitation source and a second connector attached to the second printed circuit board and coupled to the CMOS biosensor chip.

17. The apparatus of claim 16 wherein the CMOS biosensor chip is operative to measure a fluorescent decay response of at least one analyte having a fluorophore, wherein the analyte is bound to a probe molecule on the CMOS biosensor chip, and wherein the fluorescent decay response is measured at a plurality of different time periods measured from a time when the excitation source is turned off after a period during which the excitation source is turned on.

18. The apparatus of claim 17 wherein the CMOS biosensor chip is further operative to average the fluorescent decay response measured at the plurality of different time periods.

19. The apparatus of claim 16 wherein the CMOS biosensor chip is operative to measure a fluorescent decay response of at least one analyte having a fluorophore, wherein the analyte is bond to a probe molecule on the CMOS biosensor chip, and wherein the fluorescent decay response is measured a plurality of times at a time period measured from a time when the excitation source is turned off after a period during which the excitation source is turned on.

20. The apparatus of claim 19 wherein the CMOS biosensor chip is further operative to average the fluorescent decay response measured the plurality of times.
